(19) United States
(12) Patent Application Publication
(10) Pub. No.: US 2013/0084123 A1
(43) Pub. Date: Apr. 4, 2013

(54) LOOSE-LEAF BINDER

(71) Applicant: Chun-Ning TSENG, Taichung City (TW)

(72) Inventor: Chun-Ning TSENG, Taichung City (TW)

(73) Assignee: SMART FORTUNE INTERNATIONAL LIMITED, Taichung City (TW)

(21) Appl. No.: 13/250,114

(22) Filed: Sep. 30, 2011

(51) Int. Cl. B42F 13/00

(52) U.S. Cl. 402/29

(57) ABSTRACT

A loose-leaf binder, made of plastic, has one top section with a foldable section at one side. One lower clamping piece twists upside and forms a pattern of “L” with the side section which twists upsides and connects to the other side of the top section and make the top section, lower clamping piece and side section form a document saving groove. One upper clamping piece which connects to the top section at the foldable section, makes the upper clamping piece foldable compared with the top section. Thus, when the document is placed into the document saving groove, the upper clamping piece folds to the lower clamping piece, the clip section could play clipping function in ahead of the lower clamping piece, and then the clip flange leans against the interface of the lower clamping piece, and clipped together, and then it shall be clipped and fixed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a loose-leaf binder, and more particularly to an innovative construction which clamps and fixes the documents by its folding function.

2. Description of Related Art Including Information Disclosed Under 37 CFR 1.97 and 37 CFR 1.98

As is known to all, many different kinds of documents are widely used by office workers, and loose-leaf binders are adopted to store and keep them. Thus, in order to guarantee office cleanliness and order, as well as to improve working efficiency, choosing suitable binders to classify and manage the documents is an important task.

There are many kinds of loose-leaf binders sold in the market, and here, we will focus on the following two types. One is a transparent bag with holes in the side, by which users could put the documents into the bag and use together with other binders with metal buckles. The other one is a binder which keeps the documents by making holes at the side of them. Though above-mentioned binders are capable of saving the documents, many disadvantages during use still remain. For the transparent bag, it is inconvenient to save and withdraw the documents, and time would be wasted for saving the documents into or withdrawing them from the bag. Also, during these two actions, the two sides of the bags could be broken due to uneven force. For the second type, too many steps need be gone through for saving the documents, such as making holes at the sides of the documents first, and then matching the holes with the two extendable components on the binder, and after that, fixing the extendable components and the documents by a clamping component. Thus, it is inconvenient in this means, and through making holes at the side of the documents, the integrity, beauty and practicability of them are affected. Here, we are noting that the above-mentioned binders are only for saving the documents, and due to their disadvantages, they still need to be improved for convenience and practicability.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The improved effect of the present invention is stated as below.

The “loose-leafbinder” disclosed by the present invention provides an innovative clip section, upper clamping piece, foldable section, lower clamping piece and extendable plate section. Compared with the prior art, the present invention is able to provide a new pattern to fold, clamp and fix the document. Due to the structure wherein the upper clamping piece folds to the lower clamping piece, the clip section could provide a clipping function in ahead of the lower clamping piece, and clip together, making the process simple and stability guaranteed. Made of plastic, it is quite easy and quick to manufacture, high in intention, and low in cost. Besides, different types of the extendable plate are available to meet actual needs, thus improving the working efficiency and increasing the industrial benefit.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the embodiment of the loose-leaf binder in accordance with the present invention.

FIG. 2 is a perspective view of the embodiment of the loose-leaf binder connecting to the extendable plate section in accordance with the present invention.

FIG. 3 is an operation state diagram of the folding, clamping and fixing between the loose-leaf binder and document in accordance with the present invention.

FIG. 4 is a plan lateral view of the interface with friction enhancement section of the lower clamping piece of the loose-leaf binder in accordance with the present invention.

FIG. 5 is a schematic view of the binder with buckle connection to the extendable plate section of the loose-leaf binder in accordance with the present invention.

FIG. 6 is a schematic view of the ring with hanging function connection to the extendable plate section of the loose-leaf binder in accordance with the present invention.

FIG. 7 is a schematic view showing the operation state of the magnetic matter connection to the extendable plate section of the loose-leaf binder in accordance with the present invention.

FIG. 8 is a plan lateral state view of the hooking section clipping the extendable plate section of the loose-leaf binder in accordance with the present invention.

### DETAILED DESCRIPTION OF THE INVENTION

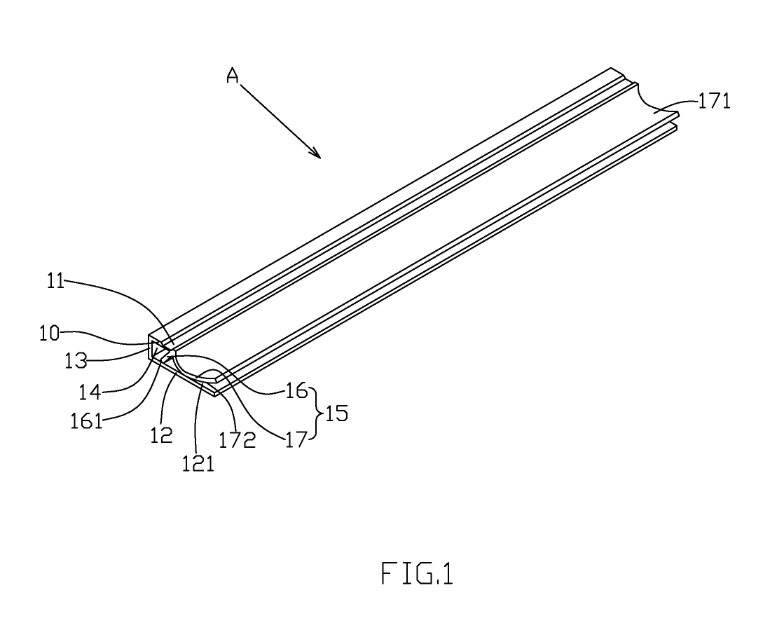

FIG. 1 shows a preferred embodiment of the loose-leaf binders, but it shall be noted that this figure is only for reference and explanation, and shall not limit the patent application. Here, the loose-leaf binder A, made of plastic, is used to clamp the document 05 (e.g. paper and notepaper), and is comprised of a top section 10 with a foldable section 11 at one side. A lower clamping piece 12 twists upside and forms a pattern of “L” with the side section 13 which twists upsides and connects to the other side of the top section 10 and make the top section 10, lower clamping piece 12 and side section 13 form a document saving groove 14. An upper clamping piece 15 connects to the top section 10 at the foldable section 11, making the upper clamping piece 15 foldable compared with the top section 10. Here, the upper clamping piece 15 comprises of a clip section 16 and a working section 17, and the latter is comprised of a pressing surface 171 and a contact surface 172, and a clip flange 161 is equipped at one side of the clip section 16. When the upper clamping piece 15 folds to the lower clamping piece 12, the clip section 16 could play clipping function ahead of the lower clamping piece 12, and then the clip flange 161 leans against to the interface 121 of the lower clamping piece 12, and clipped together.

Thus, when the document 05 is placed into the document saving groove 14, it shall be clipped and fixed under the force of the clip flange 161 of the clip section 16 and the interface 121 of the lower clamping piece 12.

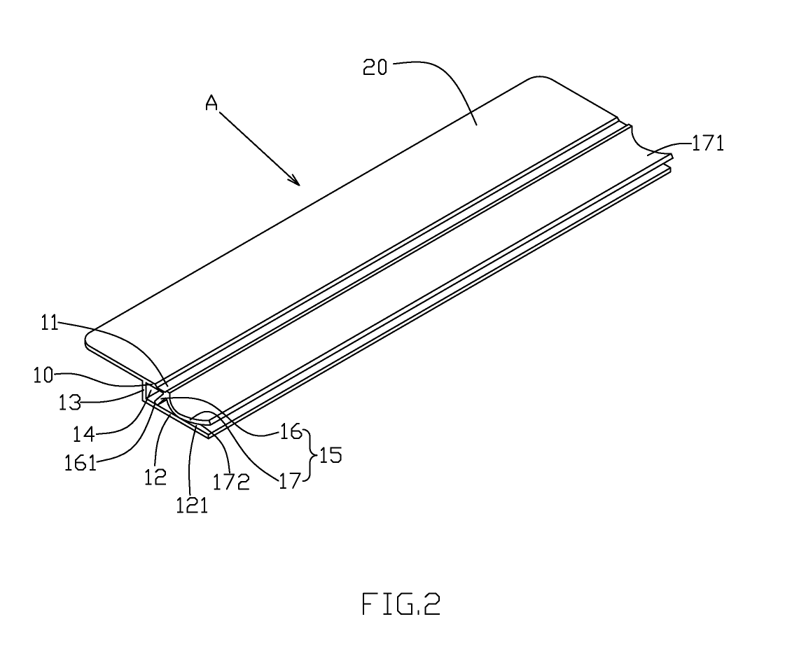

FIG. 2 shows another embodiment of the loose-leaf binder. Here, the other side surface of the side section 13 of the lower clamping piece 12 could be connected to an extendable plate section 20 to hold the loose-leaf binder A. Different types of extendable plate sections 20 are available for different articles to fix the loose-leaf binder A. Besides the above-mentioned structure introduction, the explanations for use situations and embodiments of the loose-leaf binder under the present invention are as follows. Take FIG. 2 as an example.

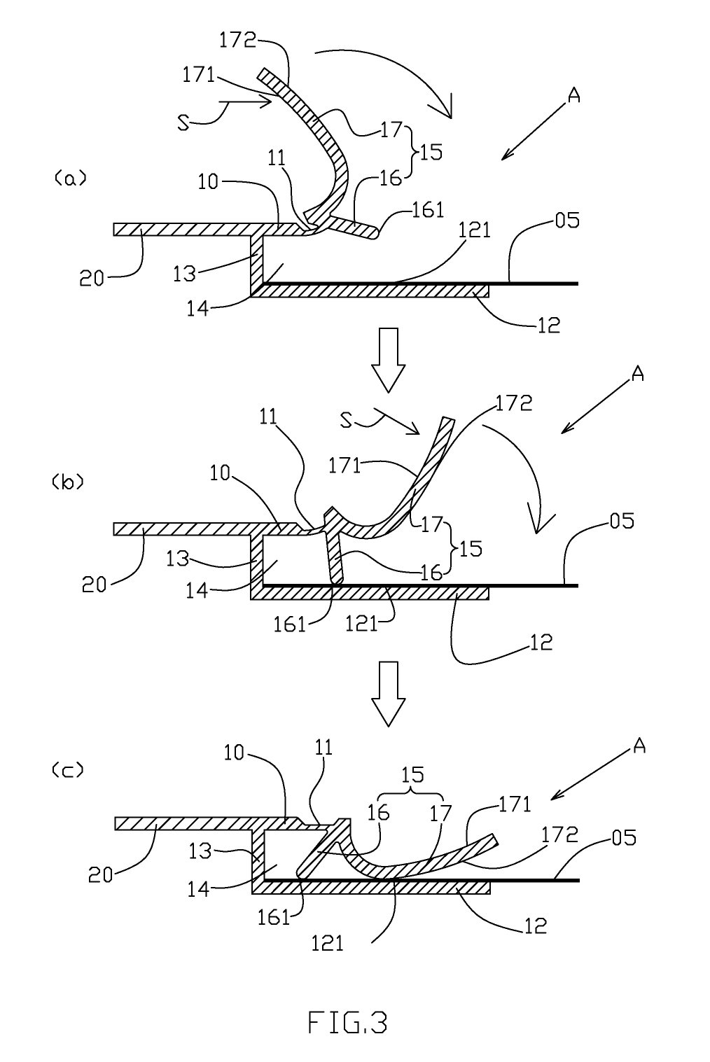

Referring to FIG. 3, here, put document 05 into the document saving groove 14, and make the upper clamping piece 15 fold upside, and fold to the lower clamping piece 12 as long as a force S is imposed on the pressing surface 171 of the working section 17 (referring to (a) in FIG. 3). Because the clip section 16 is higher than the document saving groove 14 (referring to (b) in FIG. 3, when the clip flange 161 of the clip section 16 goes against the interface 121 of the lower clamping piece 12, the force S imposed on the pressing surface 171 of the working section 17 shall be used to make the lower clamping piece 12 hold the clip section 16 upright. The foldable section 11 is elastic by bending, thus the clip section 16 could play clipping function in ahead of the lower clamping piece 12, then the document 05 shall be clipped and fixed under the force of the clip flange 161 of the clip section 16 and the interface 121 of the lower clamping piece 12 (referring to (c) of FIG. 3).

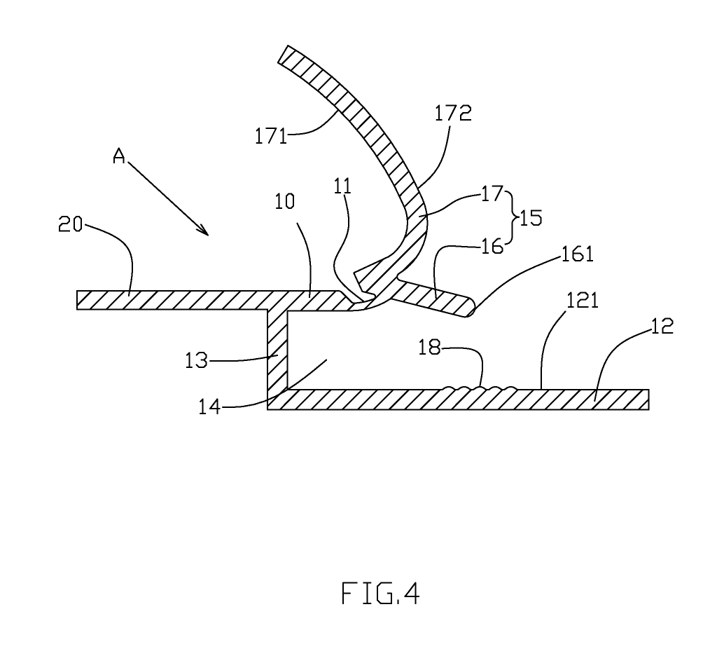

Referring to FIG. 4, a friction enhancement section 18 could be equipped on the interface section 121 of the lower clamping piece section 12. This section could be a protruding point, sharp point or serrated face, to enhance the friction coefficient (protruding point is used in this example), and finally realize the aim of fixing the document section 05 more firmly.

The friction enhancement section 18 could be set on the interface section 172 of the working section 17 or clip flange section 161 of the clip section 16 (not stated on the figure).

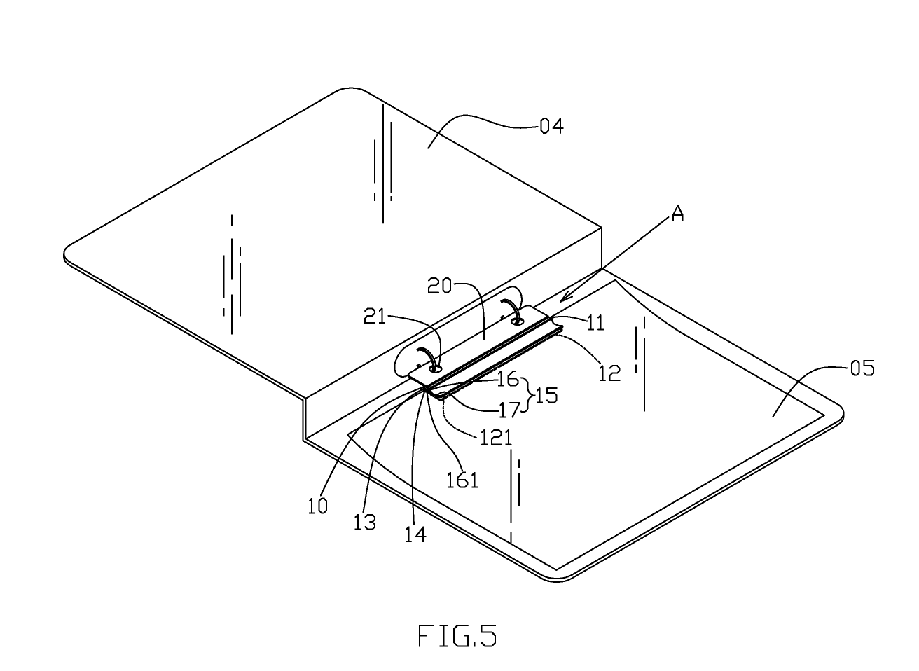

FIG. 5 shows another embodiment of the loose-leafbinder, wherein at least two through holes 21 could be set on the side of the extendable plate section 20 to make the extendable plate section 20 of the loose-leaf binder A connect to the binder 04 equipped with buckles.

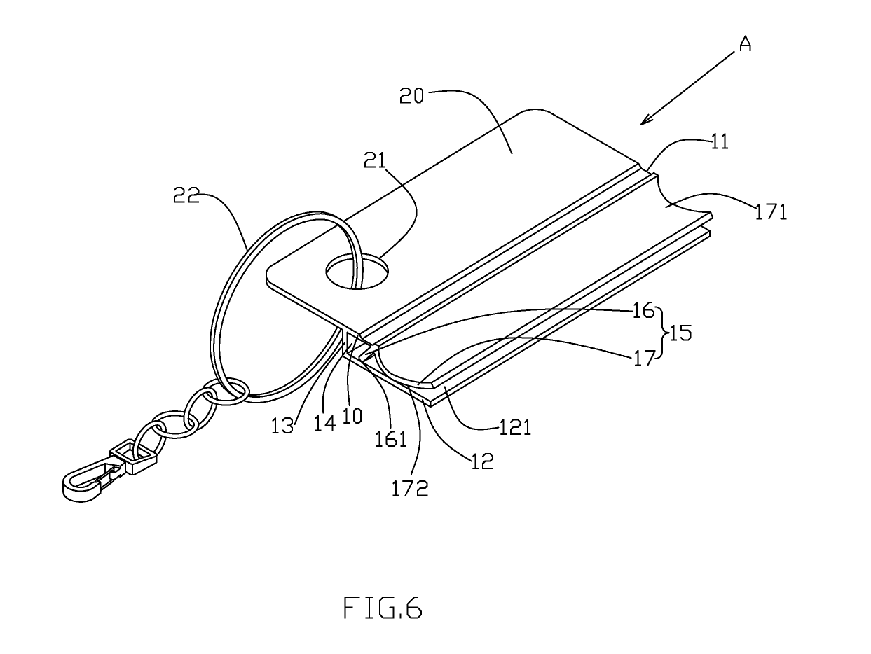

FIG. 6 shows another embodiment of the loose-leaf binder, wherein at least one through hole 21 could be set on the side of the extendable plate section 20. The loose-leaf binder A could be connected to a ring 22 by the through hole 21, and the ring 22 could be connected to articles with hanging function. Here, the loose-leaf binder A could be shortened according to actual articles, such as a key ring, to improve convenience to carry it.

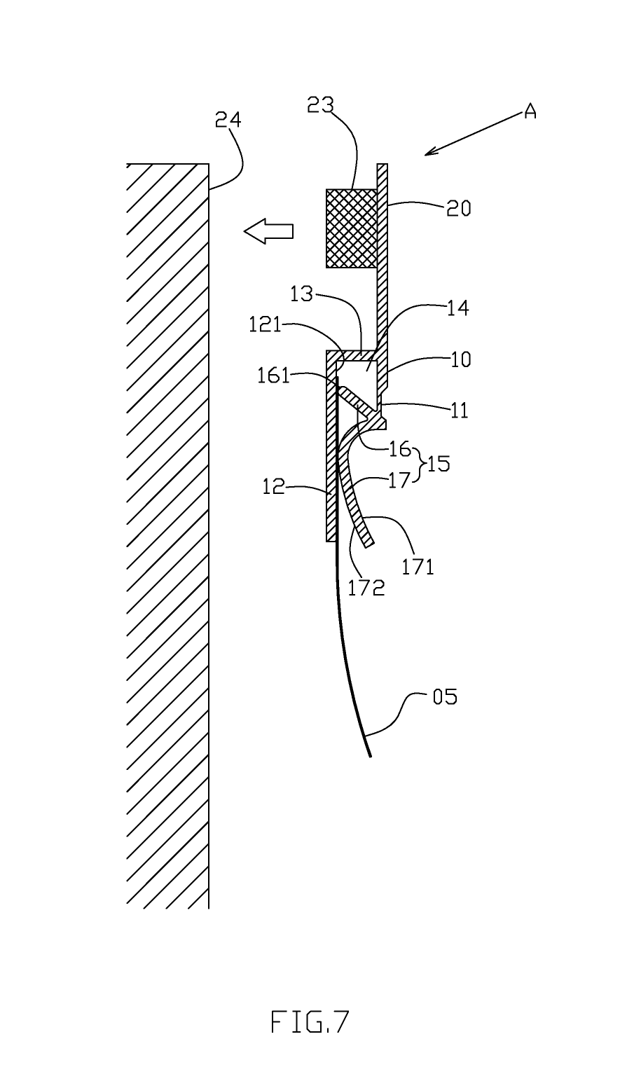

FIG. 7 shows another embodiment of the loose-leaf binder, wherein at least one magnetic matter 23 could be connected to the extendable plate section 20 to make the extendable plate section 20 of the loose-leaf binder A absorb magnetic or permeable location plate 24. The location plate could be black board or white board.

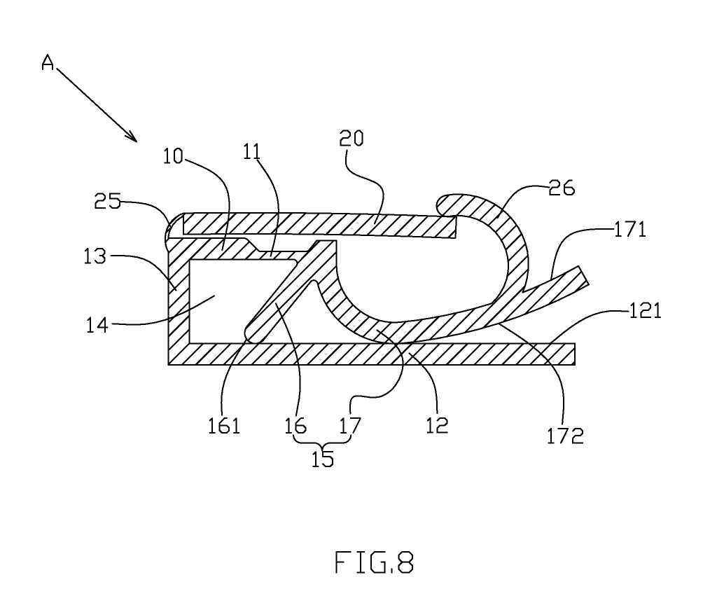

FIG. 8 shows another embodiment of the loose-leafbinder, wherein one side of the extendable plate section 20 could be connected to the side section 13 with a flanging section 25, and a hooking section 26 could be set on the pressing surface 171 of the working section 17 to make the extendable plate section 20 clip to the hooking section 26 when folds to the working section 17, and finally realize fixing aim. Through this means, space could be saved for saving and placing the loose-leaf binder A.

1. A loose-leafbinder, made of plastic, comprising:
a top section with a foldable section at one side; a lower clamping piece, twisting upside and form a pattern of “L” with the side section which twists upsides and connects to the other side of the top section and make the top section, lower clamping piece and side section form a document saving groove; an upper clamping piece which connects to the top section at the foldable section, making the upper clamping piece foldable compared with the top section; here, the upper clamping piece comprises of a clip section and a working section, and the latter is comprised of a pressing surface and a contact surface, and a clip flange is equipped at one side of the clip section; when the upper clamping piece folds to the lower clamping piece, the clip section could play clipping function in ahead of the lower clamping piece, and then the clip flange lean against to the interface of the lower clamping piece, and clipped together; thus, when the document is placed into the document saving groove, it shall be clipped and fixed under the force of the clip flange of the clip section and the interface of the lower clamping piece.

2. The structure defined in claim 1, which comprises upper and lower clamping pieces, and the working section of the former is comprised of a pressing surface, contact surface and loose-leaf binder on the clip section whose side section is connected to an extendable plate section with a side to guarantee easy holding the binder.

3. The structure defined in claim 2, wherein at least two through holes could be set on the side of the extendable plate section to make the extendable plate section of the loose-leaf binder connect to the binder equipped with buckles.

4. The structure defined in claim 2, wherein at least one through hole could be set on the side of the extendable plate section; the loose-leaf binder could be connected to a ring by the through hole, and the ring could be connected to articles with hanging function.

5. The structure defined in claim 2, wherein at least one magnetic matter could be connected to the extendable plate section to make the extendable plate section of the loose-leaf binder absorb magnetic or permeable location plate.

6. The structure defined in claim 2, wherein one side of the extendable plate section could be connected to the side section with a flanging section, and a hooking section could be set on the pressing surface of the working section to make the extendable plate section clip to the hooking section when folds to the working section, and finally realize fixing aim.

7. The structure defined in claim, wherein a friction enhancement section could be equipped on the clip flange, contact surface of the working section or interface of the lower clamping piece to realize the aim of fixing the document more stable; the friction enhancement section could be protruding point, sharp point or serrated face.
